(19) United States
(12) Patent Application Publication
(10) Pub. No.: US 2006/0271420 A1
(43) Pub. Date: Nov. 30, 2006

(54) System and method for performing capacity checks and resource scheduling within a supply chain management system

(76) Inventors: Peter Anselmann, Leimen (DE); Stefan Siebert, Hockenheim (DE); Stefan Wedner, Karlsruhe (DE); Tesfaldet Negash, Leimen (DE); Thomas Engelmann, Walldorf (DE); Thomas Schulz, Speyer (DE); Thorsten Kulick, Bensheim Schoenberg (DE); Tobias Scheuer, Edingen (DE); Volkmar Soehner, Sinsheim (DE); Anton Forstreuter, Heidelberg (DE); Bernhard Lokowandt, Heidelberg (DE); Christian Fuhlbruegge, Gaiderg (DE); Chrstian Embacher, Rauenberg (DE); Daniel Booss, Wiesloch (DE); Hans-Juergen Biegler, Schwetzingen (DE); Heinrich Braun, Karlsruhe (DE); Jan Osternmeier, Wiesloch (DE); Joachim Altmeyer, Leimen (DE)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/140,665

(22) Filed: May 27, 2005

(51) Int. Cl. G06F 15/02

(52) U.S. Cl. 705/9

(57) ABSTRACT

A system and method are described for performing bucket-oriented capacity checks on resources to determine whether activities can be processed prior to a desired delivery date. For example, a method according to one embodiment of the invention comprises: subdividing a supply chain scheduling timeline for a particular resource into a plurality of time-buckets, each of the time buckets having a specified time period and a specified total capacity supply, the total capacity supply comprising utilized capacity supply which has been consumed by previously-scheduled activities and unutilized capacity supply which is available for processing new activities; in response to receiving a customer request for a specified activity to be completed by a desired date, determining if sufficient unutilized capacity supply exists within one of the time-buckets prior to the desired date; scheduling the specified activity on the resource within the time period defined by a particular time-bucket if sufficient unutilized capacity exists within the time-bucket; and reducing the unutilized capacity by an amount of capacity supply consumed by the specified activity.

### BACKGROUND

1. Field of the Invention

This invention relates generally to the field of data processing systems. More particularly, the invention relates to a system and method for performing capacity checks and scheduling of resources within a supply chain management (“SCM”) system.

2. Description of the Related Art

### Prior Art Scheduling System

Certain software applications are designed to comprehend complicated scheduling tasks. For example, a supply-chain-management (“SCM”) software application is typically designed to comprehend the resources in a supply chain (e.g., raw materials, manufacturing equipment, distribution, warehousing, etc) and schedule their usages (also referred to as “activities”) so that a specific “supply” of product can be provided at one or more places at specific times.

FIG. 1 shows a prior art application server 101 architecture that includes SCM application software 102. The SCM application software 102 includes a scheduler function 103 that is responsible for scheduling specific activities on specific resources. As an example, if the SCM application 102 were used to schedule activities for a manufacturing facility, the SCM application 102 might contemplate the sequence of tools that form the manufacturing facility's production line(s); and, in light of specific production/purchase orders, require the scheduler 103 to schedule specific activities on the specific tools in order to satisfy these orders.

For any activity that is scheduled on a resource, the activity can be characterized in terms of its “time interval” and its “capacity demand.” The activity's “time interval” is the time period over which the resource is dedicated to the activity. An activity's “capacity demand” is the amount of the resource's capacity that the activity consumes (at a particular instant of time). For example, if the above referred to manufacturing facility where a bakery and the particular resource where an oven, the baking of a batch of baked goods could be associated with an activity requiring a specific bake start time and bake end time (which defines the activity's time interval) as well as a specific amount of internal oven space (which corresponds to the activity's capacity demand). The scheduler 103 is responsible for properly determining appropriate start and end times for an activity in light of the delivery time of the activity's respective production/purchase order, the activity's capacity demand, and the maximum capacity of the resource.

### Finite Scheduling and Infinite Scheduling

Two different types of resource scheduling, referred to generally as “finite scheduling” and “infinite scheduling” will now be described with respect to FIGS. 2-4. For the purpose of illustration, the resources used in the examples below are “single-activity” resources (i.e., resources that have the capacity to perform only one activity at a time). It will be understood, however, that the same general principles also apply to multi-activity resources.

FIG. 2 illustrates an exemplary set of relationships between five different activities performed on five different resources, Res₁-Res₅, respectively, within a supply chain order network. Activities 202 and 203 are dependent upon the results of activities 204 and 205, respectively (e.g., activities 202-203 perform operations on the results of activities 204-205). As such, activities 204 and 205 must be scheduled to be completed prior to the start of activities 202 and 203. In addition, activity 201 is dependent upon activities 202 and 203 and, as such, must be scheduled to start some time after the completion of activities 202 and 203.

In a supply chain network which involves hundreds or even thousands of interrelated activities such as those shown in FIG. 2, it is easy to see how scheduling becomes quite complex and involves a significant amount of processing overhead. As a result, it becomes difficult to schedule activities for a particular resource in an efficient manner, i.e., with no unutilized capacity between activities or overloading the resource.

To add to the complexity, the specific sequence in which a given resource executes a set of activities may have a significant impact on the efficiency with which it can complete those activities. For example, if Res₃ represents a painting apparatus within an automobile factory, the order in which different colors are used in the painting apparatus will have a significant impact on the overall efficiency with which activities are executed by Res₃. For example, if activities using different colors are used are scheduled in succession, a significant amount of “setup” and “teardown” work will be required between activities).

The foregoing issues may lead to an unsatisfactory or “fragmented” capacity utilization such as that shown in FIGS. 3-4 for Res₃. The upper timeline in FIGS. 3-4 show a set of currently-scheduled activities 301-307 and the lower timeline indicates the amount of unutilized capacity between the execution of each of the activities 301-307. In FIGS. 3 and 4, in response to a customer request, the scheduler 103 attempts to schedule a new activity 300 on Res₃ prior to a desired date. If the scheduler 103 can successfully schedule the resource, the SCM system 102 notifies the customer that the requested item/result can be delivered by the requested date. This type of real-time analysis as to whether a particular item/result can be delivered by a particular date is sometimes referred to as “available to promise” or ATP.

In FIG. 3, the scheduler 103 employs one particular technique referred to as “finite scheduling” in which it attempts to identify a guaranteed slot of time within which to schedule the activity 300. In the illustrated example, because no contiguous block time exists which is large enough to complete the activity, the activity must initially be scheduled past the customer's desired date. Although optimization algorithms within the scheduler 103 may subsequently rearrange the various activities 300-307 to ensure that the new activity is completed by the desired date, potential business may be lost because CRM system cannot initially promise the item/results in time upon receipt of the customer request.

In FIG. 4, the scheduler 103 employs another scheduling technique, referred to as “infinite scheduling,” in which it schedules the activity prior to the desired date, notwithstanding the lack of a guaranteed slot of unused capacity. As indicated in FIG. 4, this results in an over-utilization of resource Res₃. Once again, the customer cannot initially be promised the item/result by the desired date because it is unclear whether the optimization algorithms will be capable of re-sequencing the activities 300-307 to ensure an on-time delivery.

The two different scheduling techniques described above are typically used for different types of resources. For example, the “finite scheduling” techniques are typically only used for certain important resources within the supply chain where capacity is typically a constraint (e.g., bottleneck resources). By contrast, the “infinite scheduling” techniques are employed for resources for which capacity is not considered a constraint.

As mentioned above, although certain types of schedulers 103 may include optimization algorithms which rearrange the currently-scheduled activities 301-307 in a more efficient manner, these optimization algorithms require a significant amount of processing time and, therefore, are only performed periodically (e.g., once a day) rather than in response to each individual customer request. That is, these optimization algorithms cannot typically be executed as part of the so-called ATP logic employed on SCM systems for determining whether a product can be promised to a customer by a specific date.

### SUMMARY

A system and method are described for performing bucket-oriented capacity checks on resources to determine whether activities can be processed prior to a desired delivery date. For example, a method according to one embodiment of the invention comprises: subdividing a supply chain scheduling timeline for a particular resource into a plurality of time-buckets, each of the time buckets having a specified time period and a specified total capacity supply, the total capacity supply comprising utilized capacity supply which has been consumed by previously-scheduled activities and unutilized capacity supply which is available for processing new activities; in response to receiving a customer request for a specified activity to be completed by a desired date, determining if sufficient unutilized capacity supply exists within one of the time-buckets prior to the desired date; scheduling the specified activity on the resource within the time period defined by a particular time-bucket if sufficient unutilized capacity exists within the time-bucket; and reducing the unutilized capacity by an amount of capacity supply consumed by the specified activity. In one embodiment, if insufficient capacity exists within a single bucket, then the activity may be scheduled across multiple adjacent buckets.

### BRIEF DESCRIPTION OF THE DRAWINGS

A better understanding of the present invention can be obtained from the following detailed description in conjunction with the following drawings, in which:

FIG. 1 illustrates a prior art supply chain management system.

FIG. 2 illustrates relationships between resources within a supply chain order network.

FIG. 3 illustrates finite scheduling techniques employed within prior SCM systems.

FIG. 4 illustrates infinite scheduling techniques employed within prior SCM systems.

FIG. 5 illustrates a system architecture for employing bucket-based capacity checks according to one embodiment of the invention.

FIG. 6A illustrates a method for bucket-based capacity checks according to one embodiment of the invention.

FIGS. 7a-d provide a graphical example of bucket-oriented capacity checks.

FIG. 8 illustrates an exemplary computing system.

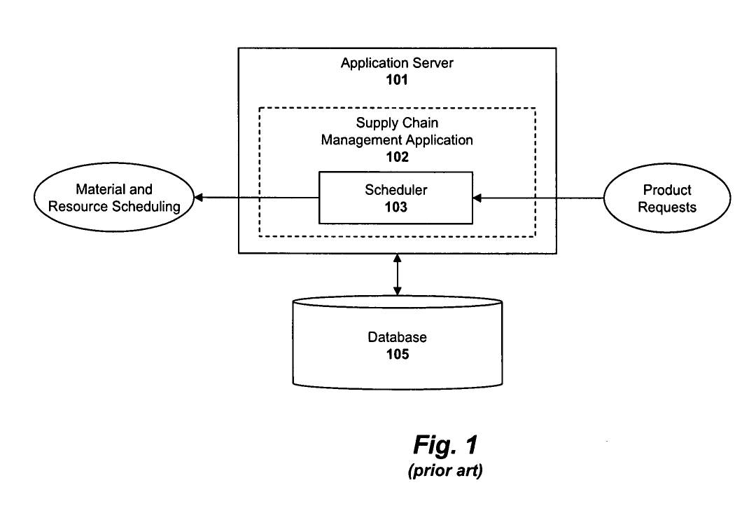

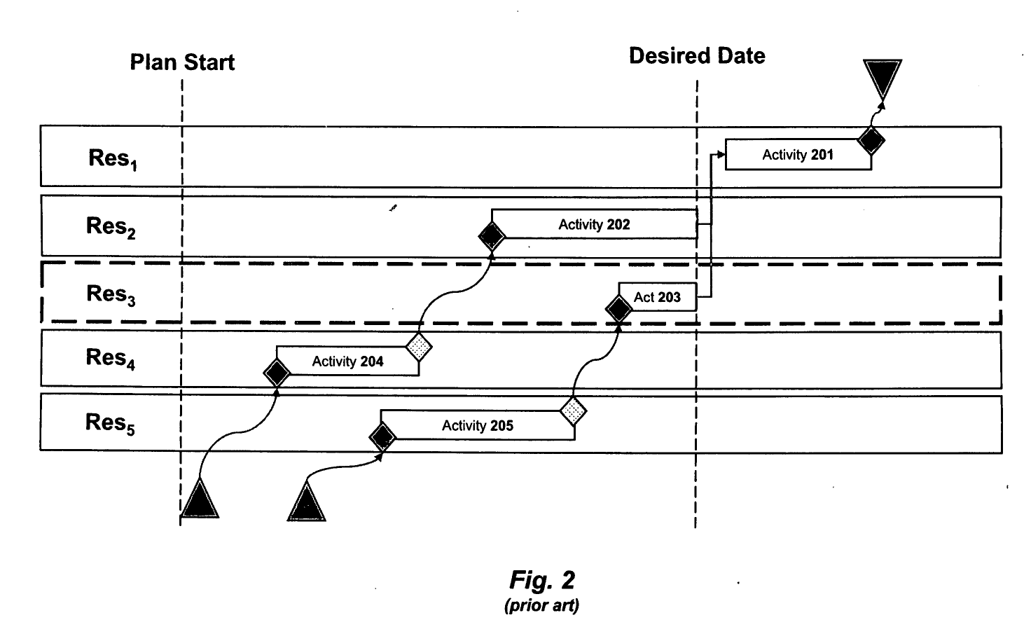

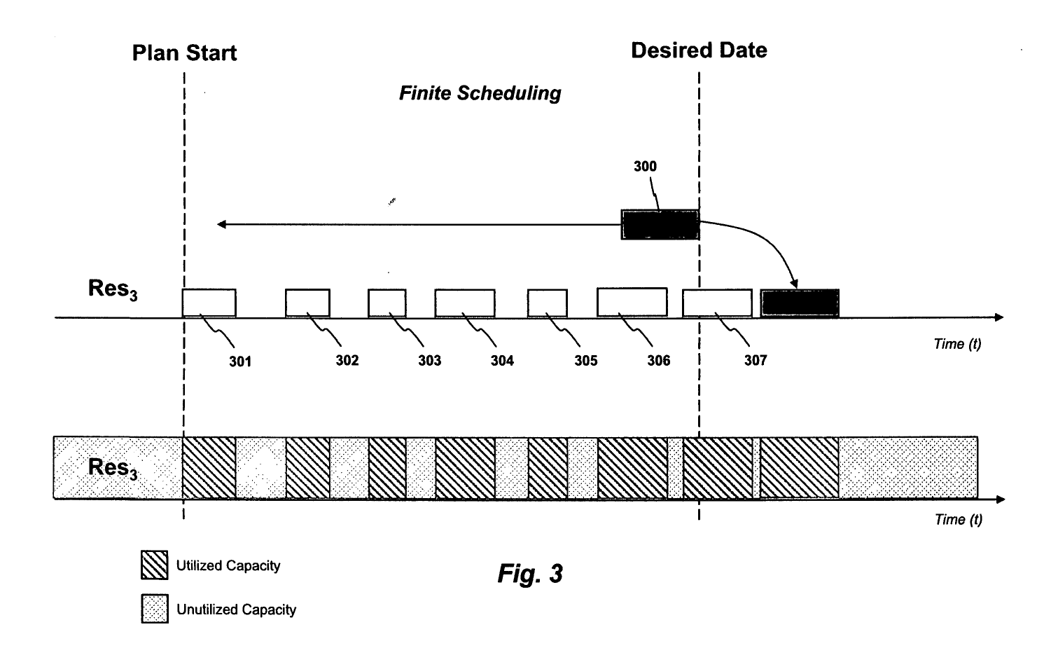

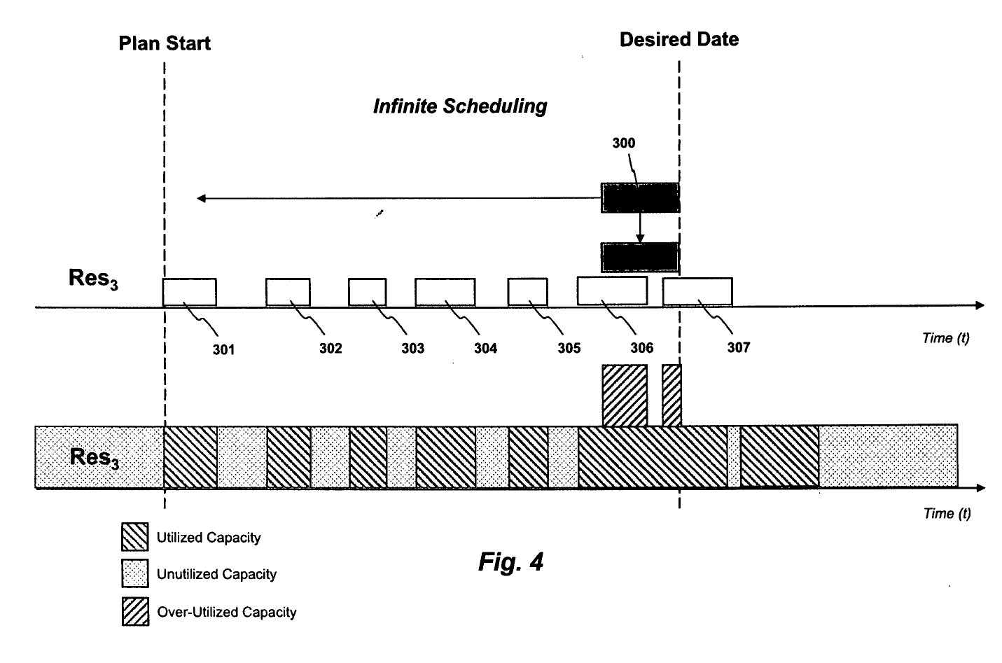

### DETAILED DESCRIPTION OF PREFERRED EMBODIMENTS

Described below is a system and method for performing bucket-oriented capacity checks within a supply chain management (“SCM”) system. Throughout the description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

### Embodiments of the Invention

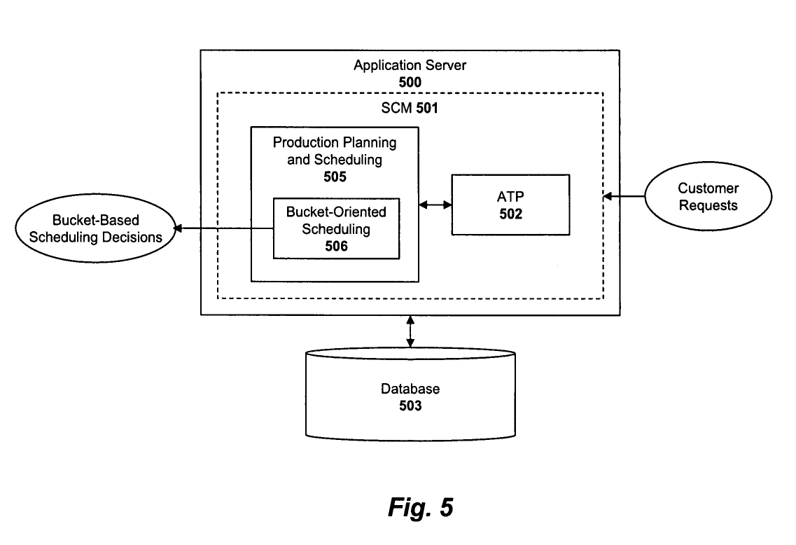

FIG. 5 illustrates an SCM application 501 executed on an application server 500 (or across a series of application servers) according to one embodiment of the invention. The SCM application 501 includes an available to promise (“ATP”) module 502 for determining whether a particular product can be delivered in response to a customer request and, if so, notifying the customer of the date on which the product can be delivered. The SCM application 501 in FIG. 5 also includes a production planning and detailed scheduling (“PP/DS”) module 505 for implementing the improved production planning and detailed scheduling (“PP/DS”) techniques described herein.

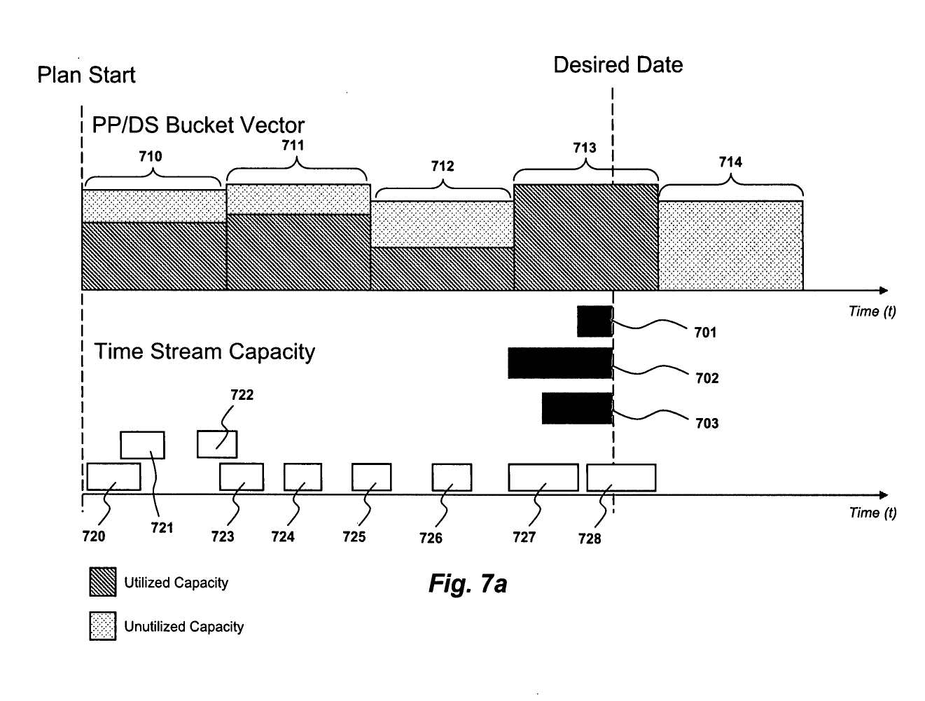

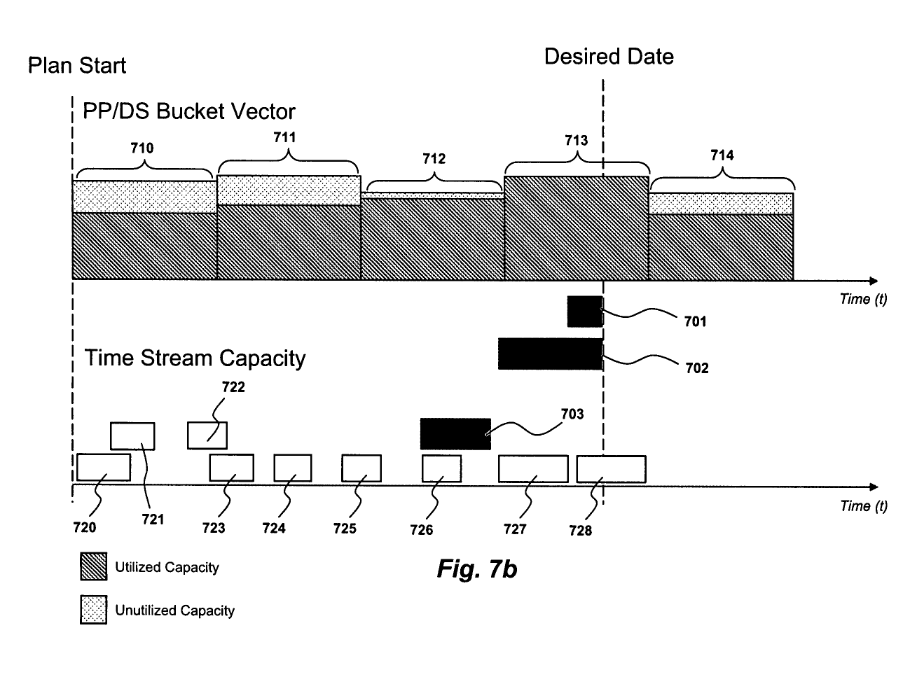

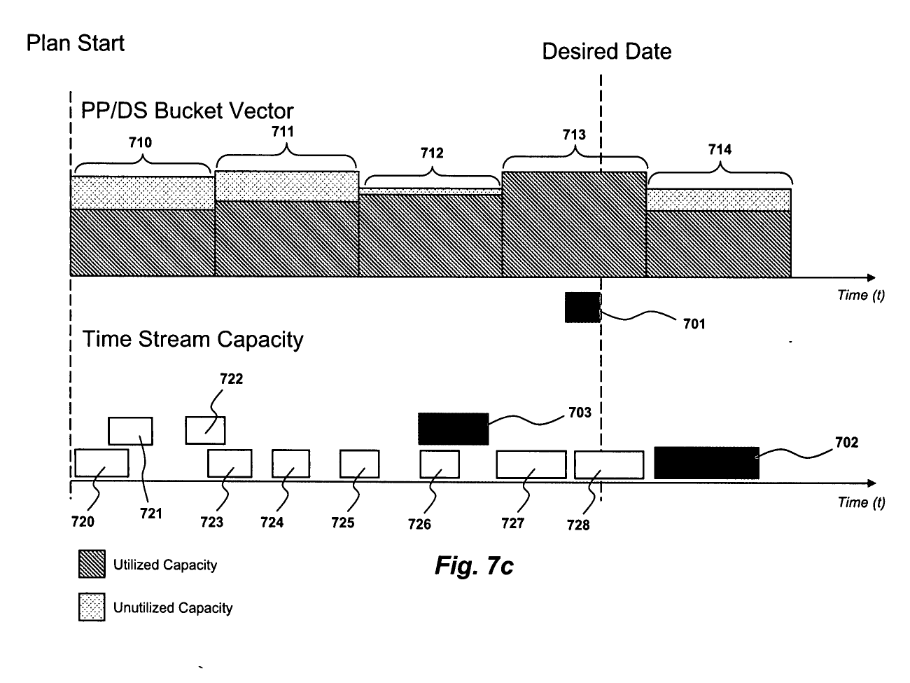

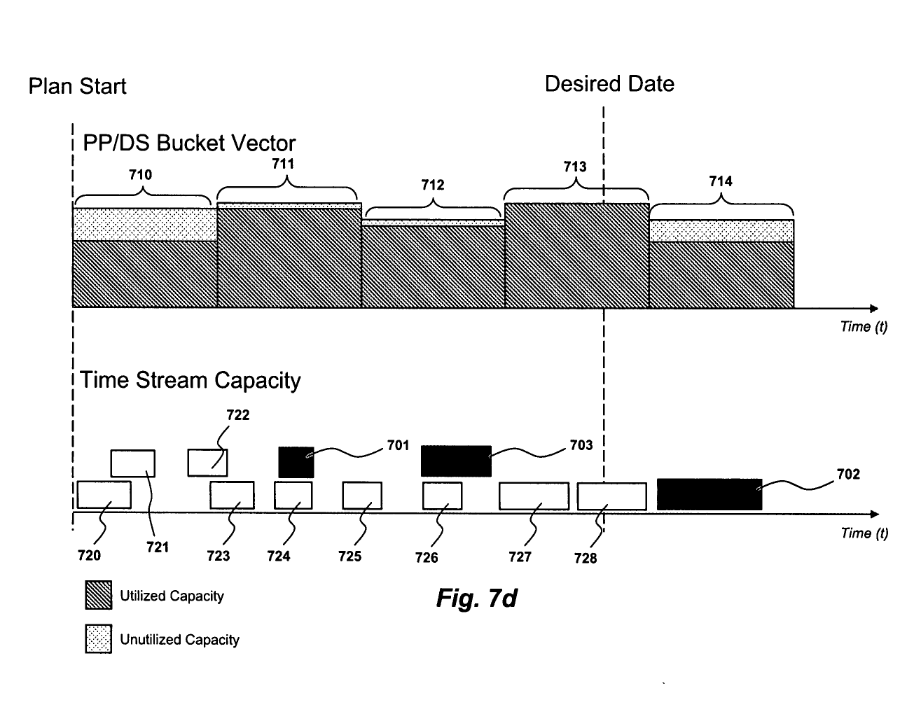

Specifically, in one embodiment, the PP/DS module includes a bucket-oriented scheduling module 506 which aggregates the capacity supply of a resource into time periods referred to herein as “time-buckets” or “buckets.” FIGS. 7a-d illustrate one example of how resource scheduling may be implemented using time-buckets. In this embodiment, the scheduling timeline is divided into a sequential series of time-buckets 710-714, referred to in combination as a “bucket vector,” each having a specified duration and capacity supply. The total capacity of each time-bucket represents the maximum capacity supply that the resource is capable of providing within the time period defined by the time-bucket. The total capacity is logically separated into “utilized” capacity and “unutilized” capacity. The utilized capacity of each time-bucket 710-714 represents the capacity already consumed by currently-scheduled activities 720-728 which fall within the scope of that time-bucket and the unutilized capacity represents the remaining capacity available for new activities 701-703.

In response to a customer request, the bucket-oriented scheduling module 506 may schedule a new activity 701, 702 or 703 within a particular time-bucket 710-714 if that time bucket has sufficient unutilized capacity to handle the activity given the current set of activities 720-728 already scheduled within that time-bucket. As a result, even though a guaranteed slot of time may not exist between two previously-scheduled activities (as is required for strict finite scheduling) the new activity may still be scheduled prior to the customer's desired delivery date if sufficient overall capacity exists within the time-bucket. As a result, although capacity is evaluated when making resource scheduling decisions, it is evaluated on a far less granular scale than with traditional finite scheduling mechanisms, thereby improving the percentage of products which can be promised to customers by a desired date.

FIG. 7b illustrates how the bucket-oriented scheduling module 506 schedules activity 703 according to one embodiment of the invention. In this embodiment, the bucket-oriented scheduling module 506 searches for the first time-bucket closest to the desired date with sufficient capacity to handle the activity 703. If no single time-bucket exists for processing the activity, in one embodiment, the bucket-oriented scheduling module 506 attempts to identify two or more adjacent time-buckets which have sufficient combined capacity to handle the activity. If so, the bucket-oriented scheduling module 506 schedules the activity across the two adjacent time-buckets. In one embodiment, if two adjacent time-buckets are used, the bucket-oriented scheduling module 506 uses all (or most) of the capacity of the time-bucket closest to the desired date and schedules the remainder of the activity within the second time-bucket (e.g., to avoid warehousing costs). In one embodiment, if more than two adjacent time buckets are used, then the time buckets in the middle must be completely available (i.e., they must not be used by any other activity).

In the illustrated example, time-bucket 712 has sufficient capacity and, as a result, activity 703 is schedule within this time-bucket. The end result of the scheduling of activity 703 is that most of the unutilized capacity within time bucket 702 is consumed, as indicated in FIG. 7b.

FIG. 7c illustrates how the bucket-oriented scheduling module 506 schedules activity 702 according to one embodiment of the invention. Once again, the bucket-oriented scheduling module 506 searches for the first time-bucket with sufficient capacity to handle the activity 702 (or the first two adjacent time-buckets with sufficient combined capacity). In the illustrated example, however, no individual time-bucket or adjacent time-buckets have sufficient capacity. Thus, the bucket-oriented scheduling module 506 schedules activity 702 after the desired date.

Finally, FIG. 7d illustrates how the bucket-oriented scheduling module 506 schedules activity 701. In this case, the first time-bucket which contains sufficient capacity to process activity 701 is time-bucket 711. Consequently, the unutilized capacity of time-bucket 711 rises based on the amount of processing the resource must perform to complete activity 701.

Various durations may be selected for the time-buckets 710-714 including, by way of example and not limitation, a shift period (e.g., 8 hours), a day, a week, a Japanese decade, and/or a month. In one embodiment, the end user is provided with a set of options for configuring the bucket size and/or capacity of each of the time-buckets.

Moreover, as illustrated in FIGS. 7a-d different time-buckets may be configured with different capacity levels to reflect the anticipated capacity of a resource during different time periods. For example, time-bucket 711 is configured with relatively greater capacity than time-buckets 710 and 712 and time-bucket 710 is configured with relatively greater capacity than time-bucket 712.

In some circumstances it may not be desirable to allow all of the capacity supply of a resource to be consumed. For example, as mentioned above, because resources may require a certain amount of downtime between activities (e.g., for setup and teardown) they cannot process activities 100% of the time. To address this issue, one embodiment of the invention is configurable to allow only a percentage of each resource to be visible to the system. For example, this embodiment may be configured to decrease the capacity of the bucket-vector by 5%, 10%, 15%, etc. The particular percentage selected may be based on the nature of the resource and the types of activities scheduled on that resource.

In one embodiment, only certain types of resources are selected for the bucket-oriented techniques described herein. For example, in one embodiment, the bucket-oriented scheduling techniques are only used for certain “primary” or bottleneck resources within the supply chain where capacity is typically a constraint. As used herein, a primary resource is the most important resource from a set of resources needed for certain activity. For example, if the activity in consideration is digging a ditch and the resources involved are a bulldozer and a number of bulldozer operators (human resources). Then the bulldozer might be considered a primary resource, whereas the operators might be considered secondary resources. That is, the operators are not constraints as compared to the bulldozer, as one of them can operate the bulldozer if the other is sick or on leave. Consequently, the capacity of the Bulldozer has to be finitely (bucket finitely) scheduled but not that the operators. By contrast, “infinite scheduling” techniques may still be employed for resources for which capacity is not considered a constraint.

For the purpose of illustration, the resources used in FIGS. 7a-d are “single-activity” resources which are capable of performing only one activity at a time. It will be understood, however, that the same general principles also apply to other types of resources such as multi-activity resources. Multi-activity resources are used to model resources on which several activities can be carried out simultaneously. For example, up to five parallel activities can be scheduled on a turnery with five lathes. Employing the bucket-oriented techniques described above on a multi-activity resource simply involves factoring in the number of concurrent activities that can be performed by the resource when making time-bucket capacity calculations (e.g., 5× the single activity capacity in the case of the turnery).

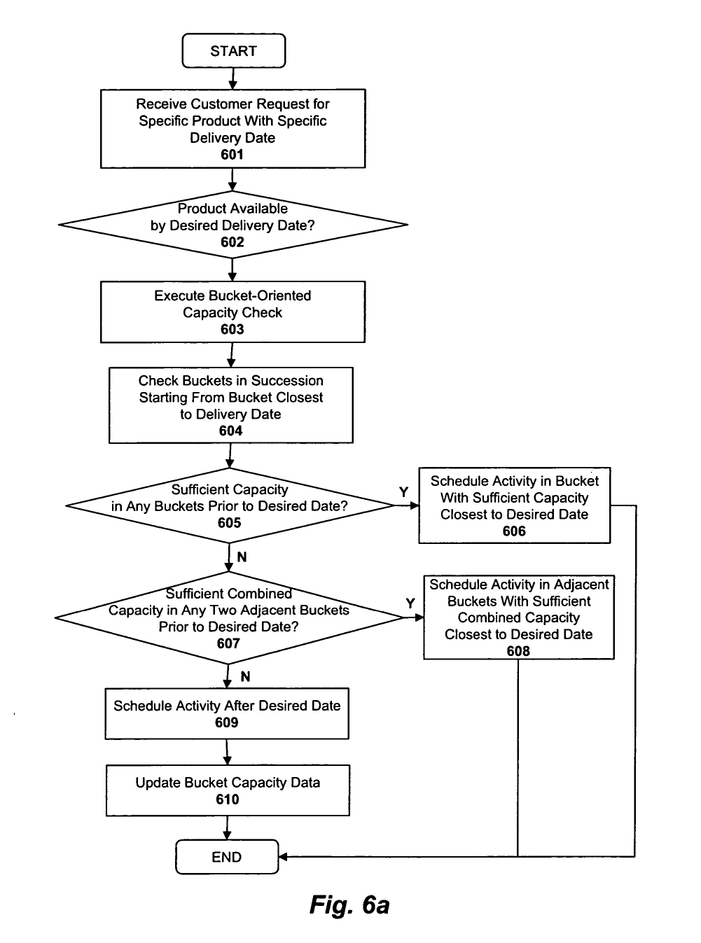

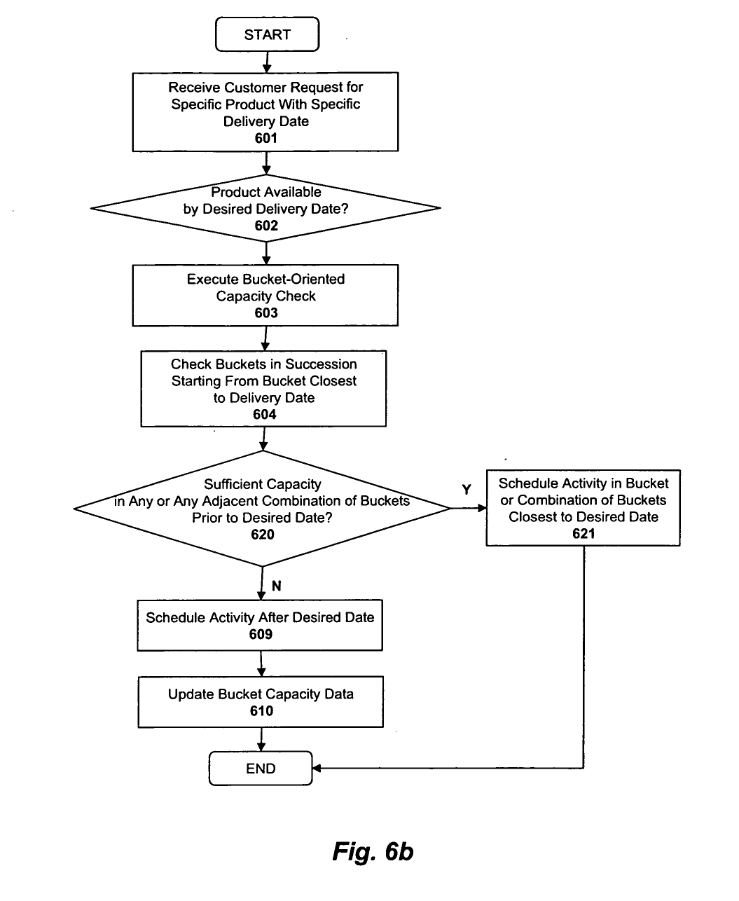

FIG. 6a illustrates a bucket-oriented scheduling process according to one embodiment of the invention. In one embodiment, the scheduling process is implemented on the architecture shown in FIG. 5. At 601, a customer request for a specific product by a specific delivery date is received by the system. At 602, a determination is made as to whether the product can be promised by the delivery date. To make this determination, the ATP module 502 may, for example, check the current inventory for the product. If the product is available, then at 611, an indication that the product will be available is sent to the customer.

If, however, the whole or part of a required quantity is not in stock, then at 603, the bucket-oriented scheduling module 506 executes a bucket-oriented capacity check to determine if sufficient capacity supply exists on one or more resources required to create the product. As described above, to make the determination, the bucket-oriented scheduling module 506 may check time-buckets in succession starting from the bucket closest to the delivery date and working towards the plan start date (i.e., to the left in FIGS. 7a-d).

If a time-bucket prior to the desired date has sufficient capacity, determined at 605, then the bucket-oriented scheduling module 506 schedules the activity (or activities) within the time-bucket at 606. However, if no time-bucket exists with sufficient capacity then, at 607, the bucket-oriented scheduling module 506 determines whether any two or more adjacent time-buckets have sufficient combined capacity. If so, then at 608 the bucket-oriented scheduling module 506 schedules the activity in the two or more adjacent time-buckets. If not, then at 609, the bucket-oriented scheduling module 506 schedules the activity after the desired date. Finally, at 610 the time-bucket capacity data is updated based on the newly-scheduled activities.

FIG. 6b illustrates an alternate embodiment for performing bucket-oriented capacity planning. Elements 601-604 are the same in FIG. 6b as in FIG. 6a. However, unlike FIG. 6a, at 620 a determination is made as to whether sufficient capacity exists in any single buckets or in any combination of adjacent buckets prior to the desired date. If so, then at 621, the bucket-oriented scheduling module 506 schedules the activity in the bucket or the combination of buckets which will allow the activity to be completed closest to the desired date. Accordingly, this embodiment ensures that the activity will be completed as close to the desired date as possible. That is, it does not discriminate between individual buckets and adjacent bucket combinations when making scheduling decisions.

In one embodiment, the ATP module 502 and PP/DS module 505 contain program code provided with the Advanced Planner & Optimizer (“APO”) SCM application currently available from SAP AG. It should be noted, however, the underlying principles of the invention are not limited to any particular version of ATP or PP/DS program code.

In addition to performing the bucket-oriented capacity check as described above, one embodiment of the invention performs scheduling in continuous time. This is illustrated in the following set of examples. Assuming that daily buckets are used for the capacity check, that the activity requires 10 minutes, that the activity is interruptible by breaks such as the non-working time over night, and that daily working time is from 8:00 until 17:00 hours. If the requirement time for delivery is 15:00 hours and the bucket provides sufficient capacity, then the activity is scheduled from 14:50 to 15:00 hours. However, if the requirement time is 20:00 hours (non-working time) and the bucket provides sufficient capacity, then the activity is scheduled from 16:50 to 17:00.

If the requirement time is 15:00 hours and the bucket does not provide sufficient capacity, but the previous bucket does, then the activity is scheduled from 16:50 to 17:00 hours on the previous day. If the requirement time is 15:00 hours, the current bucket provides only 5 minutes capacity, and the previous bucket more than 5 minutes. Then the activity is scheduled from 16:55 the previous day until 08:05 hours the current day. By contrast, an interruptible activity, which requires capacity from two adjacent buckets is scheduled in such a way that the activity durations in the two buckets corresponds with the capacity used from the two buckets.

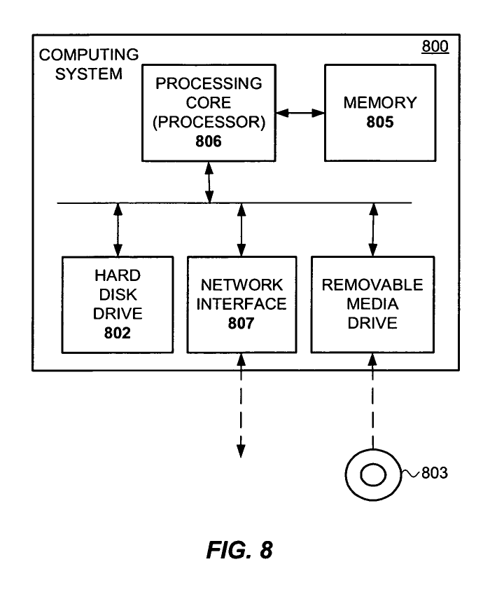

FIG. 8 is a block diagram of an exemplary computing system 800 that can execute program code stored by an article of manufacture. It is important to recognize that the computing system block diagram of FIG. 8 is just one of various computing system architectures on which the embodiments of the invention may be implemented. The applicable article of manufacture may include one or more fixed components (such as a hard disk drive 802 or memory 805) and/or various movable components such as a CD ROM 803, a compact disc, a magnetic tape, etc. In order to execute the program code, typically instructions of the program code are loaded into the Random Access Memory (RAM) 805; and, the processing core 806 then executes the instructions. The processing core may include one or more processors and a memory controller function. A virtual machine or “interpreter” (e.g., a Java Virtual Machine) may run on top of the processing core (architecturally speaking) in order to convert abstract code (e.g., Java bytecode) into instructions that are understandable to the specific processor(s) of the processing core 806. In one particular embodiment, the computing system 800 is the SAP Web Application Server currently available from SAP AG.

It is believed that processes taught by the discussion above can be practiced within various software environments such as, for example, object-oriented and non-object-oriented programming environments, Java based environments (such as a Java 2 Enterprise Edition (J2EE) environment or environments defined by other releases of the Java standard), or other environments (e.g., a .NET environment, a Windows/NT environment each provided by Microsoft Corporation).

Embodiments of the invention may include various steps as set forth above. The steps may be embodied in machine-executable instructions which cause a general-purpose or special-purpose processor to perform certain steps. Alternatively, these steps may be performed by specific hardware components that contain hardwired logic for performing the steps, or by any combination of programmed computer components and custom hardware components.

The present invention may also be downloaded as a computer program which may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. For example, although the description above focused on single-activity resources, the same general principles apply to other resources (e.g., multi-activity resources). Accordingly, the scope and spirit of the invention should be judged in terms of the claims which follow.

What is claimed is:

1. A method comprising:
subdividing a supply chain scheduling timeline for a particular resource into a plurality of time-buckets, each of the time buckets having a specified time period and a specified total capacity supply, the total capacity supply comprising utilized capacity supply which has been consumed by previously-scheduled activities and unutilized capacity supply which is available for processing new activities;
in response to receiving a customer request for a specified activity to be completed by a desired date, determining if sufficient unutilized capacity supply exists within one of the time-buckets or within a combination of adjacent time buckets prior to the desired date;
scheduling the specified activity on the resource within the time period defined by a particular time-bucket or combination of time buckets if sufficient unutilized capacity exists within the time-bucket or combination of time buckets; and
reducing the unutilized capacity within the time buckets or combination of time buckets by an amount of capacity supply consumed by the specified activity.

2. The method as in claim 1 wherein the time bucket or series of time buckets are selected based on which time bucket or combination of adjacent time buckets will allow the activity to be completed closest to the desired date.

3. The method as in claim 2 further comprising:
scheduling the specified activity after the desired date if no single time-bucket or no two adjacent time-buckets includes sufficient unutilized capacity to process the specified activity.

4. The method as in claim 2 wherein scheduling the specified activity on the resources within a time period spread across adjacent time-buckets comprises:
consuming substantially all of the unutilized capacity from the one of the adjacent time-buckets which is relatively closer to the desired date; and
scheduling the remainder of the activity within the one or more of the adjacent time-buckets which is relatively further from the desired date.

5. The method as in claim 1 further comprising:
prior to determining if sufficient unutilized capacity supply exists within one of the time-buckets or combination of time buckets prior to the desired date, initially checking to determine if a product resulting from the specified activity is already in stock and deliverable to the customer by the desired date; and
promising a product resulting from the specified activity to the customer by the desired date.

6. The method as in claim 1 further comprising:
if sufficient unutilized capacity supply exists within one of the time-buckets is combination of adjacent time buckets prior to the desired date then promising a product resulting from the specified activity to the customer by the desired date.

7. The method as in claim 1 further comprising:
in response to the customer request, initially determining whether the particular resource is to be processed is a primary resource within the supply chain; and
if the resource is not considered a primary resource, then utilizing infinite scheduling techniques to schedule the activity on the resource.

8. A system comprising:
a bucket-based scheduling module to subdivide a supply chain scheduling timeline for a particular resource into a plurality of time-buckets, each of the time buckets having a specified time period and a specified total capacity supply, the total capacity supply comprising utilized capacity supply which has been consumed by previously-scheduled activities and unutilized capacity supply which is available for processing new activities;
wherein, in response to receiving a customer request for a specified activity to be completed by a desired date, the bucket-based scheduling module determines if sufficient unutilized capacity supply exists within one of the time-buckets or combination of adjacent time-buckets prior to the desired date and schedules the specified activity on the resource within the time period defined by a particular time-bucket or adjacent time-buckets; and further reduces the unutilized capacity in the time-bucket or combination of adjacent time-buckets by an amount of capacity supply consumed by the specified activity.

9. The system as in claim 8 wherein the time bucket or series of time buckets are selected based on which time bucket or combination of adjacent time buckets will allow the activity to be completed closest to the desired date.

10. The system as in claim 9 wherein the bucket-oriented scheduling module schedules the specified activity after the desired date if no single time-bucket or combination of adjacent time-buckets includes sufficient unutilized capacity to process the specified activity.

11. The system as in claim 9 wherein scheduling the specified activity on the resources within a time period spread across the combination of adjacent time-buckets by the bucket-oriented scheduling module further comprises:
consuming substantially all of the unutilized capacity from the one of the adjacent time-buckets which is relatively closer to the desired date; and
scheduling the remainder of the activity within the one or more of the adjacent time-buckets which is relatively further from the desired date.

12. The system as in claim 8 further comprising:
an available to promise module which, prior to the determination by the bucket-based scheduling module determining if sufficient unutilized capacity supply exists within one of the time-buckets or combination of adjacent time buckets prior to the desired date, initially checks to determine if a product resulting from the specified activity is already in stock and deliverable to the customer by the desired date; and promises a product resulting from the specified activity to the customer by the desired date.

13. The system as in claim 8 wherein, if sufficient unutilized capacity supply exists within one of the time-buckets or combination of adjacent time-buckets prior to the desired date then the bucket-oriented scheduling module promises a product resulting from the specified activity to the customer by the desired date.

14. The system as in claim 8 further comprising:
production planning and detailed scheduling module (PP/DS) which, in response to the customer request, initially determines whether the particular resource is to be processed is a primary resource within the supply chain; and if the resource is not considered a primary resource, then utilizes infinite scheduling techniques to schedule the activity on the resource.

15. A machine-readable medium having program code stored thereon which, when executed by a machine, cases the machine to perform the operations of:
subdividing a supply chain scheduling timeline for a particular resource into a plurality of time-buckets, each of the time buckets having a specified time period and a specified total capacity supply, the total capacity supply comprising utilized capacity supply which has been consumed by previously-scheduled activities and unutilized capacity supply which is available for processing new activities;
in response to receiving a customer request for a specified activity to be completed by a desired date, determining if sufficient unutilized capacity supply exists within one of the time-buckets or within a combination of adjacent time buckets prior to the desired date;
scheduling the specified activity on the resource within the time period defined by a particular time-bucket or combination of time buckets if sufficient unutilized capacity exists within the time-bucket or combination of time buckets; and
reducing the unutilized capacity within the time buckets or combination of time buckets by an amount of capacity supply consumed by the specified activity.

16. The machine-readable medium as in claim 15 wherein the time bucket or series of time buckets are selected based on which time bucket or combination of adjacent time buckets will allow the activity to be completed closest to the desired date.

17. The machine-readable medium as in claim 16 further comprising:
scheduling the specified activity after the desired date if no single time-bucket or no two adjacent time-buckets includes sufficient unutilized capacity to process the specified activity.

18. The machine-readable medium as in claim 16 wherein scheduling the specified activity on the resources within a time period spread across adjacent time-buckets comprises:
consuming substantially all of the unutilized capacity from the one of the adjacent time-buckets which is relatively closer to the desired date; and
scheduling the remainder of the activity within the one or more of the adjacent time-buckets which is relatively further from the desired date.

19. The machine-readable medium as in claim 15 comprising additional program code to cause said machine to perform the operations of:
prior to determining if sufficient unutilized capacity supply exists within one of the time-buckets or combination of time buckets prior to the desired date, initially checking to determine if a product resulting from the specified activity is already in stock and deliverable to the customer by the desired date; and
promising a product resulting from the specified activity to the customer by the desired date.

20. The machine-readable medium as in claim 15 comprising additional program code to cause said machine to perform the operations of:
if sufficient unutilized capacity supply exists within one of the time-buckets is combination of adjacent time buckets prior to the desired date then promising a product resulting from the specified activity to the customer by the desired date.

21. The machine-readable medium as in claim 15 comprising additional program code to cause said machine to perform the operations of:
in response to the customer request, initially determining whether the particular resource is to be processed is a primary resource within the supply chain; and
if the resource is not considered a primary resource, then utilizing infinite scheduling techniques to schedule the activity on the resource.
